(19) United States
(12) Patent Application Publication
(10) Pub. No.: US 2004/0145168 A1
(43) Pub. Date: Jul. 29, 2004

(54) Steering column and manufacturing method thereof

(76) Inventor: Olaf Muller, Russelsheim (DE)

Correspondence Address: FLEIT KAIN GIBBONS GUTMAN & BONGINI, COURVOISIER CENTRE II, SUITE 404, 601 BRICKELL KEY DRIVE, MIAMI, FL, 33131, US

(21) Appl. No.: 10/725,963

(22) Filed: Dec. 1, 2003

Related U.S. Application Data
(63) Continuation-in-part of application No. 10/030,774, filed on Jun. 3, 2002, now abandoned.

(51) Int. Cl. B62D 1/11; B62D 1/18; B62D 1/19

(52) U.S. Cl. 280/777

(57) ABSTRACT

A steering column in which an outer housing, a steering shaft housing and/or a guiding plate include an extruded profile. Furthermore, a manufacturing method for a steering column whereby an outer housing, a steering shaft housing and/or a guiding plate are at least partly made of extruded profile.

### CROSS-REFERENCE TO RELATED APPLICATIONS

This is a continuation-in-part of U.S. patent application Ser. No. 10/030,774 filed Jun. 3, 2002. The contents of which are incorporated by reference in their entirety.

### BACKGROUND OF THE INVENTION

1. Field of the Invention

The invention generally refers to a steering column and a manufacturing method thereof.

2. Prior Art

Current casings for steering columns for motor vehicles are metal sheet constructions or assemblies of mainly aluminium or magnesium cast parts. New requirements as for multiple load restrictions for different accident types, integrated air bags, movement cylinders for certain crash types and other things make these components increasingly expensive.

### BRIEF SUMMARY OF THE INVENTION

Therefore, the invention has the object to provide a steering column as well as a manufacturing method thereof wherein expensive treatment, costs and weight are saved.

Therefore, according to the present invention it is provided to use at least one extruded or extrusion profile or shape for a housing of the steering columns. Thereby the variety of requirements correspondingly to which the components are mounted in and/or at the housing of the steering column in an easy way, are optimally taken into consideration.

The object is especially achieved by a steering column as well as a manufacturing method thereof according to the attached claims.

Thus, a steering column is provided in which an outer housing, a steering shaft housing and/or a guiding plate include an extruded or extrusion profile or shape.

Preferably, in the extruded profile or in the extruded profiles means for longitudinal and/or vertical adjustment of the steering column are accommodated. Especially these means for longitudinal and/or vertical adjustment of the steering column are accommodated in the extruded profiles of the guiding plate and of the outer housing.

Alternatively or additionally, it can be provided that means for the accident-caused movement of the steering column away from the driver are accommodated in the extruded profile or in the extruded profiles. A preferred further development thereof is that the means for the accident-caused movement of the steering column away from the driver include load absorbing means which are accommodated in the extruded profile or in the extruded profiles wherein the load absorbing means include especially two load absorbencies which can be activated or deactivated in dependence on preconditions determined by sensors that detect, i.e. the belt fastened condition, position of the driver and/or the size of the driver. Furthermore, it is of advantages in the present embodiment if the means for the accident-caused movement of the steering column away from the driver is accommodated in the extruded profiles of the guiding plates and of the outer housing. Furthermore, the means for the accident-caused movement of the steering column away from the driver can include pyrotechnic driving means which are accommodated in the extruded profile or the extruded profiles. It can further be provided with preference that the means for the accident-caused movement of the steering column away from the driver include pyrotechnic unlocking means for the longitudinal adjustment of the steering column and/or unlocking or locking means for the load absorbing means.

In the steering column, according to the invention, it can be further provided that means for the protection of the driver's knees or legs are integrated in the extruded profile or in the extruded profiles. These means for the protection of the driver's knees or legs preferably include a knee/leg air bag and/or a knee impact plate especially movable towards the driver in an accident and preferably load absorbingly mounted.

The object of the invention is also achieved by a manufacturing method for a steering column wherein an outer housing, a steering shaft housing and/or a guiding plate are at least partly made of extruded or extrusion profile or shape.

Further preferred and advantageous embodiments of the invention result from the combination of the claims as well as the complete disclosure of the present document.

### BRIEF DESCRIPTION OF THE SEVERAL VIEWS OF THE DRAWINGS

In the following, the invention is explained in more detail based on the exemplary embodiment examples with reference to the drawings. In the drawings:

FIGS. 1 to 11 show different sections of a basic first embodiment example of the steering column or apparatus with some, given the case, alternative design variants, specifically:

FIG. 1 shows an especially simple form of a longitudinally and vertically adjustable steering.

FIG. 2 shows the support of the steering shaft housing in a swivel bearing.

FIG. 3 shows a development of this steering column meeting the requirement to have a steering-integrated air bag, two crash-depending load absorbencies and an active pyrotechnically activated steering column.

FIG. 4 shows an enlarged view of longitudinal section F of FIG. 3.

FIG. 5 shows section A of FIG. 3.

FIG. 6 shows section B of FIG. 3.

FIG. 7 shows section C of FIG. 3.

FIG. 8 shows section D of FIG. 3.

FIG. 9 shows a further alternative of the steering shaft housing.

FIG. 10 shows the steering shaft in the steering shaft housing, the lock screw and the swivel bearing in the horizontal section E.

FIG. 11 shows the lock of the comfort adjustment on both sides as an alternative to the basic embodiments in FIGS. 1 and 2.

FIGS. 12 to 17 show different sections of a second embodiment example of the steering column or apparatus with some, given the case, alternative design variants.

Equal reference symbols in the individual figures and illustrations of the drawings refer to equal or similar or equally or similarly working components. Based on the illustrations in the drawings such features become evident which do not have reference symbols independent on the fact whether such features are subsequently described or not. On the other hand, features which are included in the present description, but not visible or illustrated in the drawings are easily evident to a ordinary person skilled in the art.

### DETAILED DESCRIPTION OF THE INVENTION

In all figures of the drawings, a steering column is as far as it is illustrated or visible therein is generally marked, with the reference numeral 100.

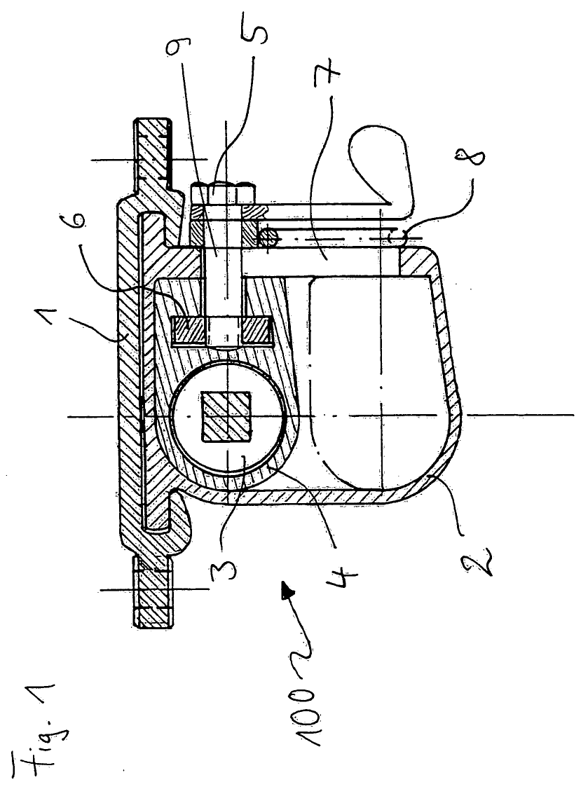

FIG. 1 shows an especially simple form of a longitudinally and vertically adjustable steering column which can be provided, for example, with a load absorbing sheet (not shown) in a position integrated in a guiding plate 1. In this guiding plate 1, an outer housing 2 is guided, which moves in a crash relative to the guiding plate 1 upon, e.g., destruction/load reduction by a deformable load absorbing sheet (not shown) and which can also be called steering column housing.

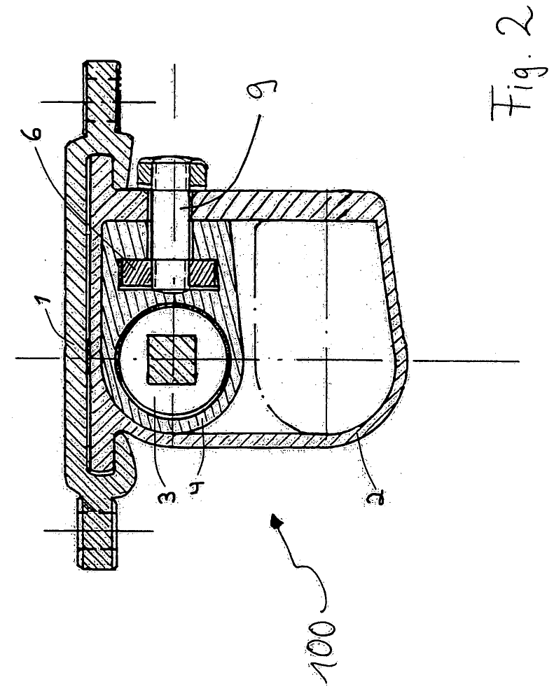

In this outer housing 2, a steering shaft 3 lies in a steering shaft housing 4. This steering shaft housing 4 can be longitudinally and vertically adjusted after releasing a lock screw 5 by means of a positioning lever 6 with a lock element in an adjustment slot 7. Hereby, an equalizing spring 8 in the form of a “coil spring” acts against the weight of the steering shaft 3. FIG. 2 shows the support of the steering shaft housing 4 in a swivel bearing 9.

All parts of this vertically and longitudinally adjustable steering column are cheaply produced as extruded or extrusion profile or shape. The outer housing 2 is shiftable in the guiding plate 1 since the crash case completely surrounds the vertically and longitudinally adjustable shaft housing 4. This has the advantage that there are no projecting components injuring the knees in a crash. The lock screw 5 is also cost-savingly guided in a longitudinal slot of the extruded profile of the steering shaft housing 4. The swivel bearing 9 is also positioned in this adjustment slot 7 and, of course, swivably mounted in the outer housing 2. On the whole, a cost-effective, compact longitudinally and vertically adjustable steering column assembly without projecting parts being harmful in a crash.

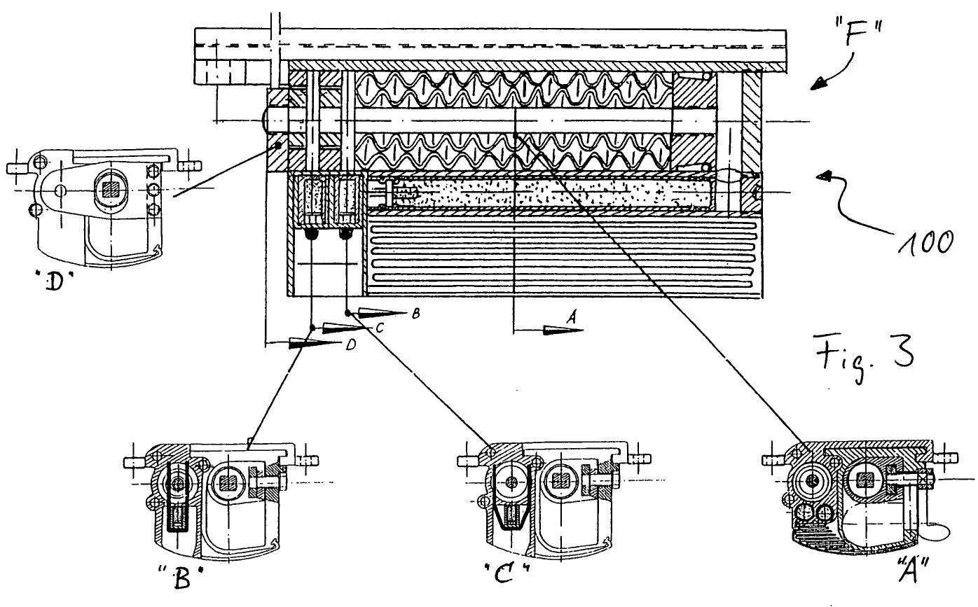

FIG. 3 shows a development of this steering column meeting the requirement to have a steering-integrated air bag, two crash-depending load absorbencies and an active pyrotechnically activated steering column. FIG. 3 shows the association of the sections of the following figures as an overview. Herein the object according to the invention is also to accommodate further elements of the passive safety in the extruded or extrusion profile or shape of an “extended” outer housing 2 from FIGS. 1 and 2 in a most simple and cost-effective way.

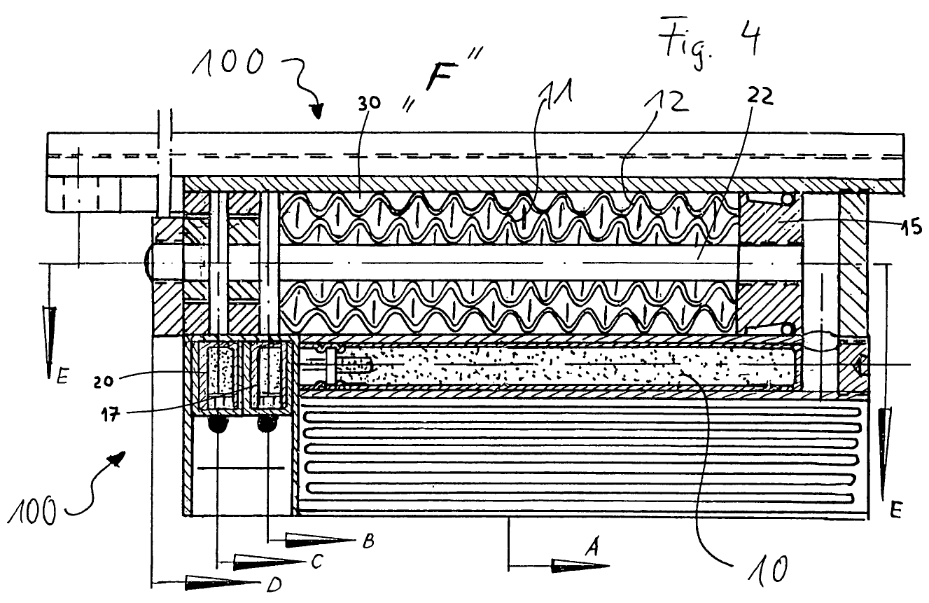

FIG. 4 shows in an enlarged view the longitudinal section F of FIG. 3 with load absorbencies 11 and 12 forming the load absorbing means, and a pyrotechnic driving generator 10. Two interweaving load absorbencies 11 and 12 are accommodated in a cylinder-shaped cavity 30 together with a piston 15 and a piston rod 22 connected for crash alternatives described later on. Furthermore, the longitudinal section of FIG. 4 shows the generator 10 needed if required to “lower” the steering column (not shown). All these elements are simply accommodated in the extruded or extrusion profile or shape of the outer housing 2. At the lower side of the extruded profile outer housing 2 there are pyrotechnic cartridges 17 and 20 to unlock depending on the crash situation the load absorbencies/absorbency 11 and/or 12.

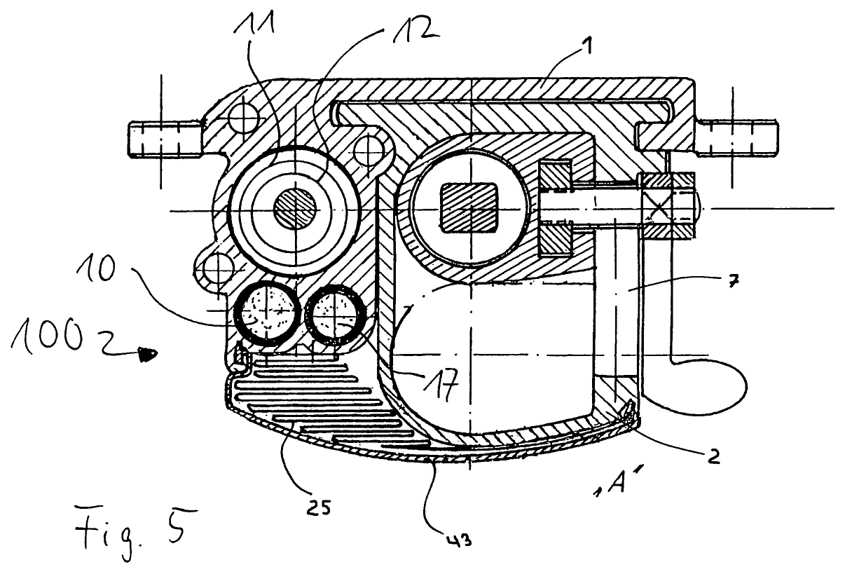

In the section A of FIG. 3 shown in FIG. 5 in the outer housing 2, the mounting of the load absorbencies 11 and 12, and adjacent to the generator 10 for the movement of the piston 15 the mounting of a generator 17 for an air bag 25 are shown. The latter is closed by a cover 43. Further details correspond to those ones of the previous FIGS. 1 to 4. This section A shows furthermore the interleaving steering column correspondingly to FIGS. 1 and 2 with a guiding plate similar to the guiding plate 1 in a modified form for supporting the elements mentioned above. All elements are optimally “inter-left” and accommodated in the direction of the extruded or extrusion profile or shape.

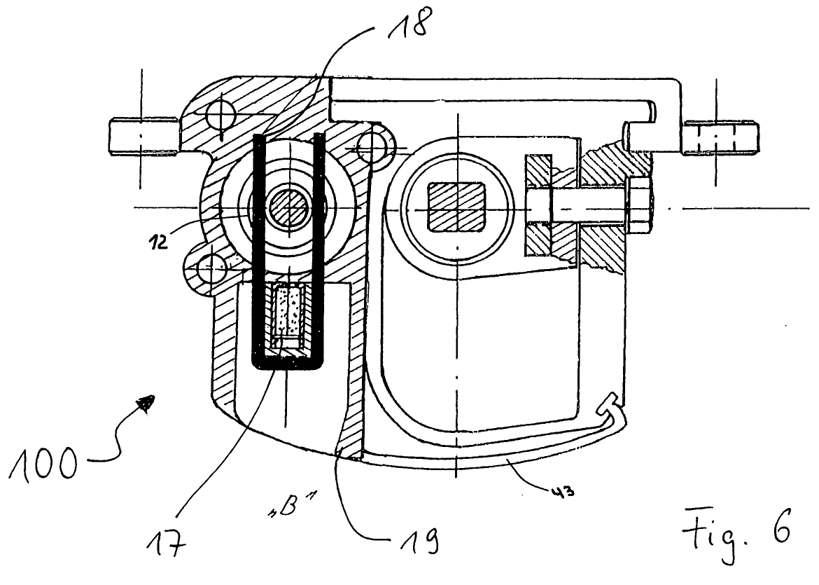

In the section B of FIG. 3, illustrated in FIG. 6, an unlocking casing 19 screwed on the outer housing 2 is shown in a section. An unlocking 18 (in this case as a clamp) is seen. Bolts, plates or the like could also be used. A pyrotechnic cartridge 17 pulls the unlocking 18 of the load absorbency 12 away in an accident according to a pregiven programming after a load absorbency.

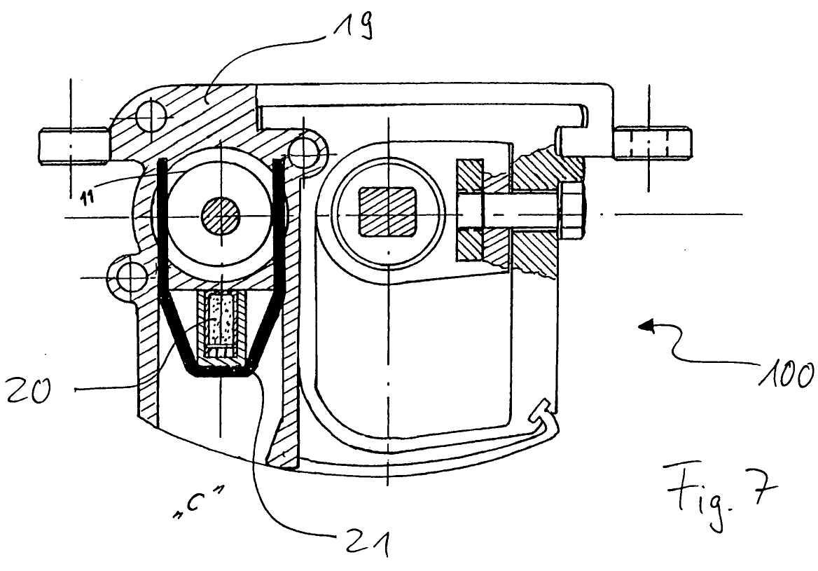

In the section C of FIG. 3, shown in FIG. 7, an unlocking 21 release of the outer load absorber 11 is seen. A second cartridge 20 belongs thereto.

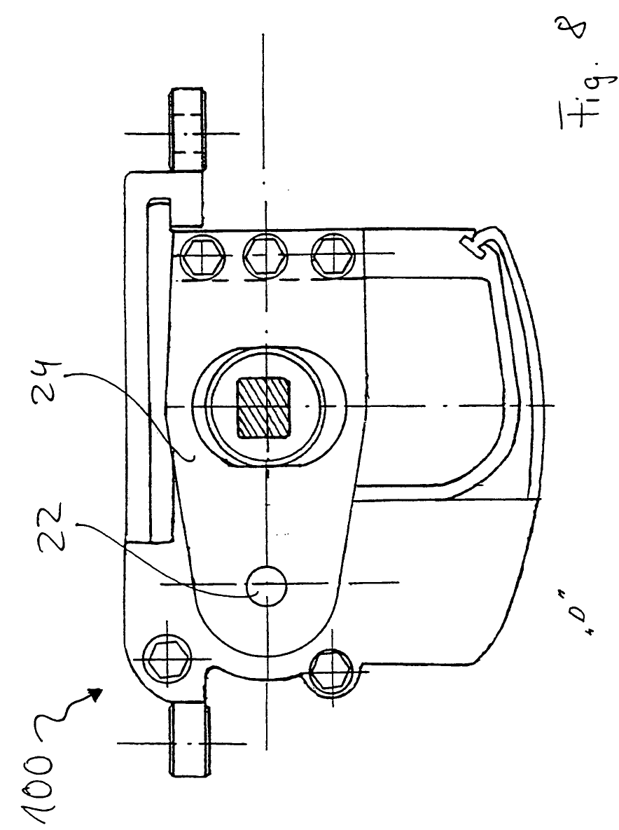

In the section D of FIG. 3, illustrated in FIG. 8, a connecting tab 24 is shown which via a piston rod 22 is connected to the “outer housing” 23 again via the load absorbencies 11 and 12.

Function in an Accident or a Crash

The crash-relevant requirements to a steering column of the described embodiment were basically described in the PCT/DE 00/02286 relating to the same applicant. Herewith, the disclosure of this PCT application with regard to the function of a retractable steering column is completely included in this present document to avoid mere repeating description.

If a tall man is not wearing a seat belt (detection, e.g., by means of switch in seat belt buckle), so he will need both load absorptions 11 and 12 to absorb sufficient energy during the movement of the inner to the outer housing. If the driver is wearing a seat belt, the inner load absorbency 12 will be unlocked and only the load absorbency 11 will be effective.

If a small person is sitting close to the steering column, so he/she will not need a load absorbency (air bag is sufficient). Both load absorbencies 11 and 12 will be unlocked and the inner housing will be driven to the front together with the steering column mounted thereon to generate sufficient distance to the person. The small persons' presence is detected, for example, by electric seat position detection in the seat rails and seat belt retraction and/or weight detection. The knee air bag together with its generator and tissue is also an integrated component of the extruded profile.

The electronic detection system (not shown) may be integrated into the steering column components to allow for activating or deactivating load absorbers, pyrotechnic cartridges, air bag and/or one or more of the described components. A system of sensors or detection means can be pre-programmed to respond to different crash conditions or load absorbencies or act in a particular sequence in case of an accident. The steering components may also, in an alternative design, be manually activated or deactivated by the driver. For example, the load absorbers or pyrotechnic cartridges may be manually engaged or disengaged.

Advantages are the most simple manufacturing of the highly complicated housing with multiple elements which are arranged in such a way that they can perform their pre-determined movements in parallel to the longitudinal direction or perpendicular thereto.

In the sectional view of FIG. 9 a further alternative is shown in which the housing 23 for the longitudinal and vertical adjustment of the steering column with electro-motors (not shown) is an integral component of the steering shaft housing 4. Furthermore, in this alternative a knee air bag 25 is integrated in such a way that a rear supporting wall 26 is an integral component of the outer housing 2. Both adjustment motors (not shown) are fitted in serial in the housing in such a way that the rear one with its rear drive spindle (not shown) carries out the longitudinal adjustment and the front motor with a vertically adjusted drive spindle (not shown) carries out the vertical adjustment. Herein, too, everything is designed “suitably for extruded profiles”.

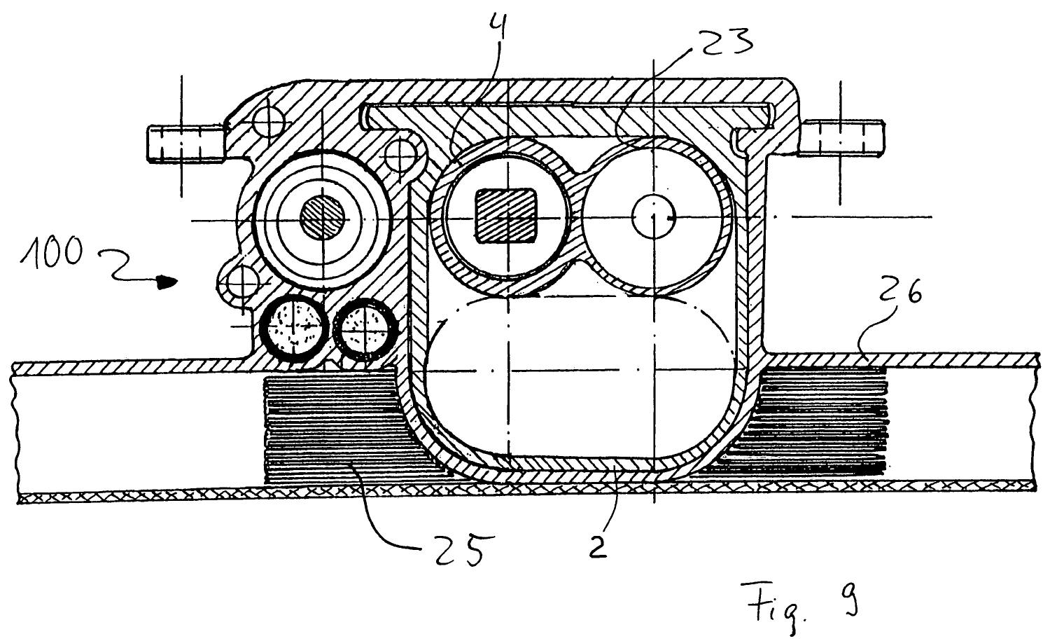

FIG. 10 shows the steering shaft 3 in the steering shaft housing 4, the lock screw 5 and the swivel bearing 9 in the horizontal section E. The outer housing 2 with the load absorbencies 11 und 12 and the thereto belonging unlockings 13 and 14 in the unlock casing 19 lie in parallel thereto. The steering column is driven to the front by the piston 15 on the piston rod 22 in the case of small drivers and in the second crash phase. A reverse lock 16 prevents a steering column once driven to the front from pushing backwards again by the front wall. Load absorbencies 11 and 12 and the piston 15 are connected with each other with a connecting tab 24 for the force transmission as described further above in connection with FIG. 8 and shown in the latter.

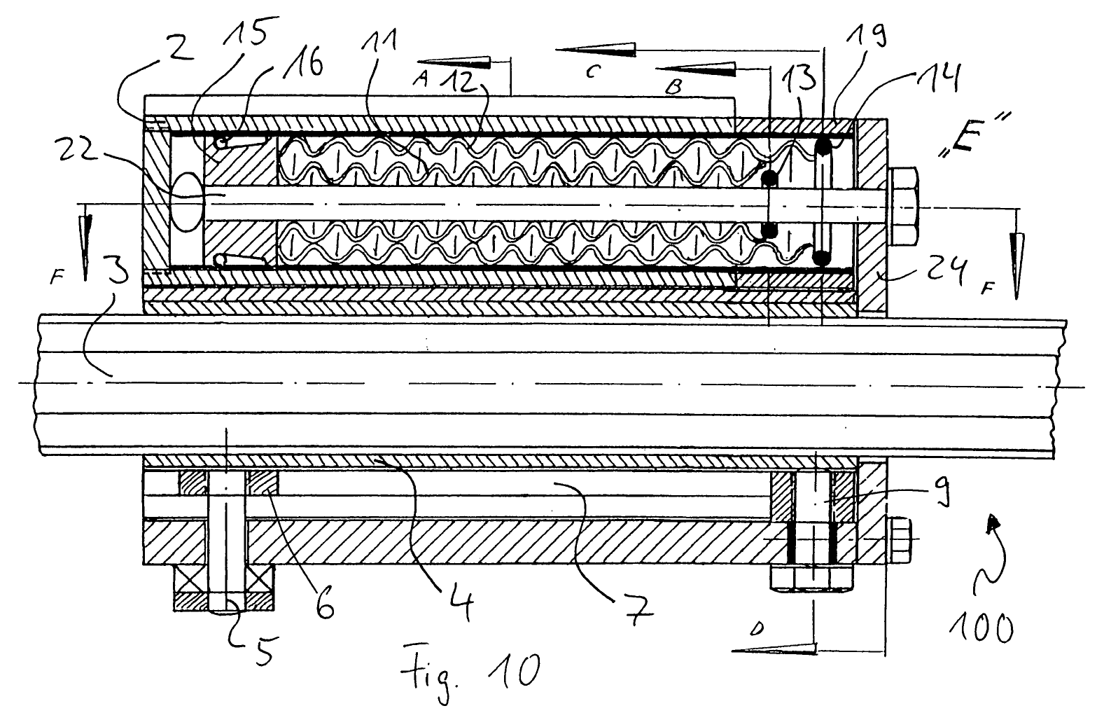

FIG. 11 shows the lock of the comfort adjustment on both sides as an alternative to the basic embodiments in FIGS. 1 and 2. This is more expensive but possibly of advantage for the reduction of vibrations. According to the invention from left to right, the tolerance is compensated by a bellville spring block 27 each. A load transmission casing 28 made of solid material surrounds the steering shaft housing 4 made of light metal extruded profile according to the invention, for the support of the steering shaft 3 of the gliding stones 29 and the bellville springs 27.

This is also a solution in which the benefits of an extruded profile come in completely useful. The benefits of extruded or extrusion profiles or shapes have their roots in the fact that with low costs for tools, extrusion matrices are made in which complicated structural types (holes, grooves, walls, projections) can be extruded if they basically run in parallel to one direction. Therefore, the shown steering columns were illustrated in different embodiment types and the complex accommodation of load absorbers, pistons, pyrotechnic drive sets, component guides, screw holes and so on integrated in one single or in two components movable towards each other in a crash is shown.

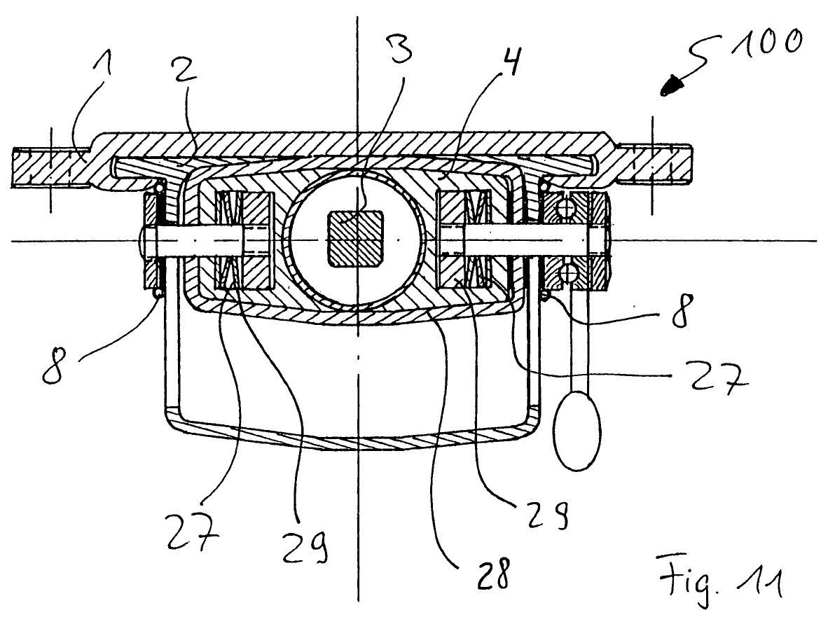

As another embodiment alternative, FIG. 12 shows the combination of a guiding plate with load absorbers, a pyrotechnic adjustment in the case of a crash and a knee air bag similar to what is illustrated and described thereto in the above mentioned embodiment examples and furthermore in combination with a steering column adjustment with metal sheet tabs.

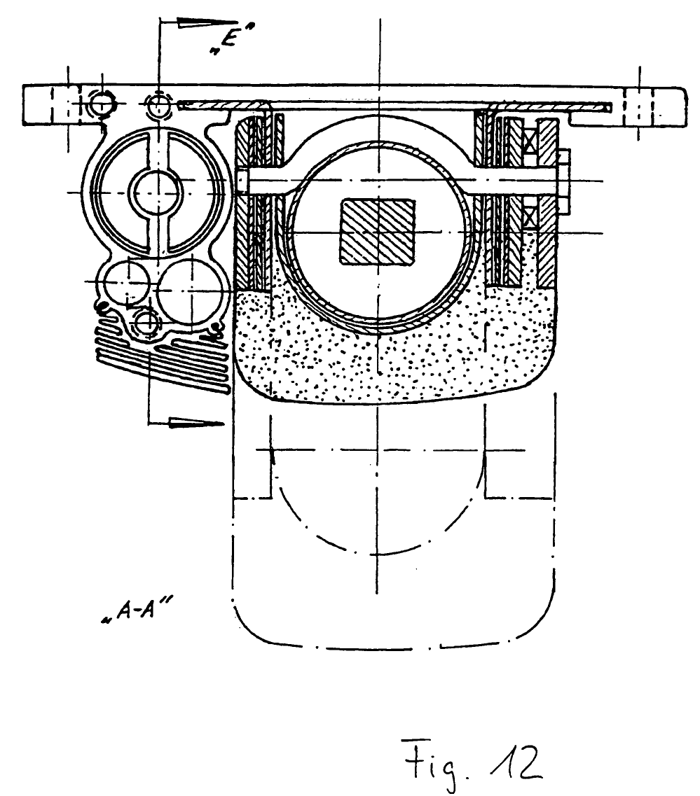

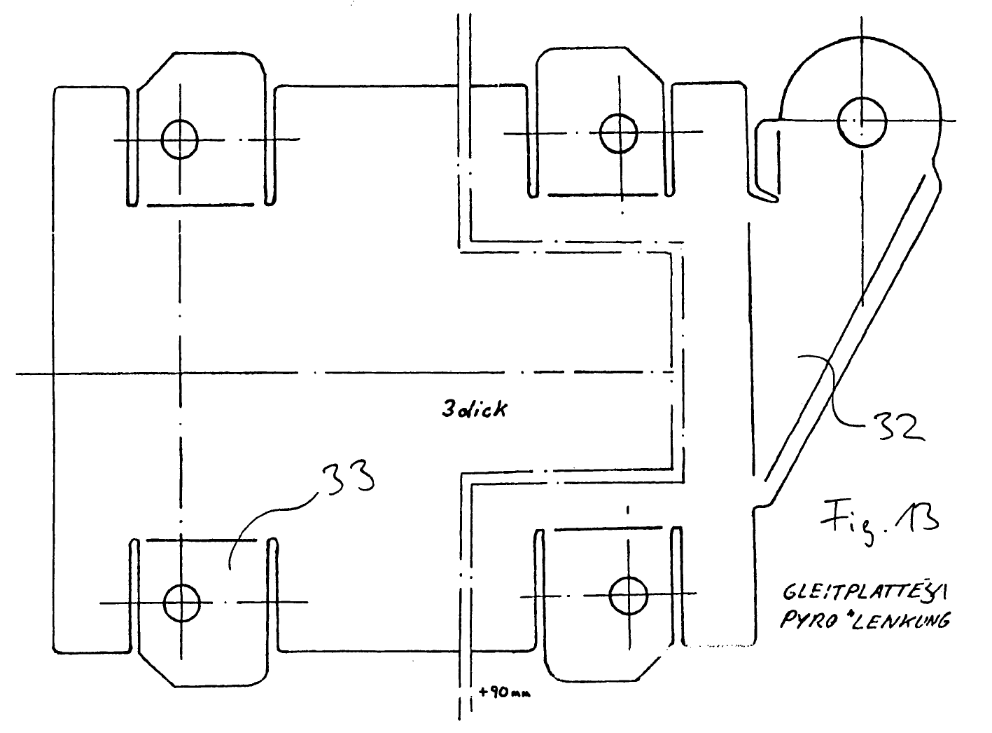

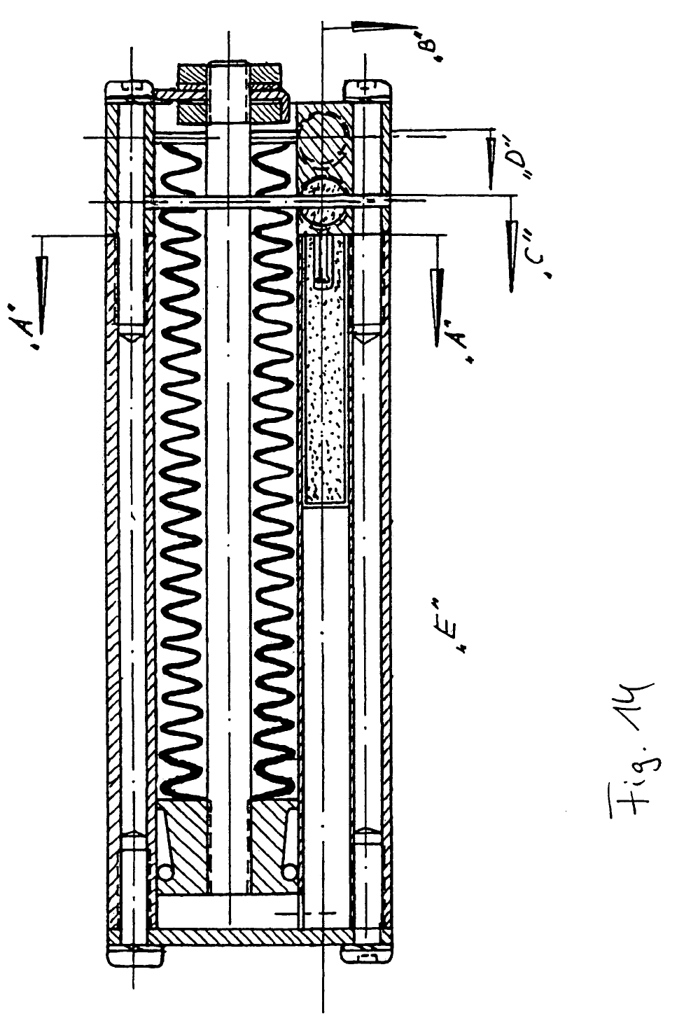

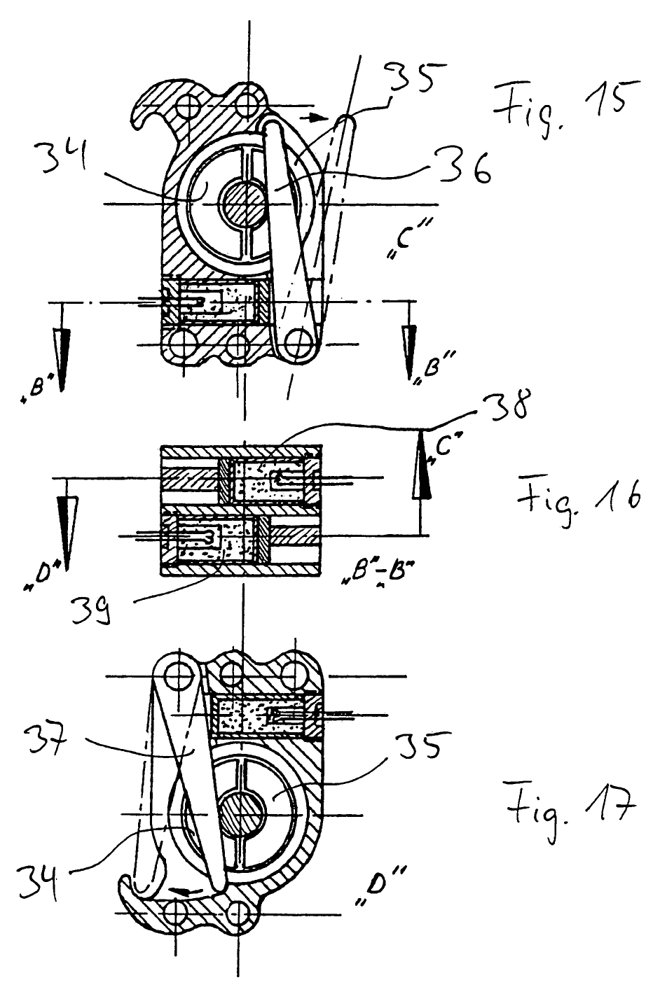

For the support of this novel steering column a sliding or slip plate 31 according to FIG. 13 with an integrated driver 32 for load absorber 34 and 35 and the piston rod 22 according to the invention is explained. FIG. 14 shows a similar section of this embodiment correspondingly to FIG. 4 and, therefore, is not separately described except of the following differences: In the middle, FIG. 15 shows corrugated tubes as the load absorbers 34 and 35. In FIG. 15 section C a lever 36 is shown locking or, in certain described crash conditions, “unlocking” the load absorber 35. FIG. 17 shows in parallel the locking or unlocking of the load absorber 34 by means of a lever 37 depending on the crash condition. FIG. 16 shows the pyrotechnic unlocking cartridges 38 and 39 in section B. FIG. 14 shows the position of the sections A, B, and C in the steering housing or casing 40. Furthermore, FIG. 14 shows the casings 41 and 42 for the unlocking of the load absorbers 34 and 35 correspondingly to FIGS. 15, 16 and 17 from the front and in the unscrewed condition.

Advantages of the single variants, as to be seen in the figures of the drawing, will be indicated in the following.

From the views of FIGS. 1 and 2, it is to be seen that the guiding plate and the steering housing is made with an integrated vertically and longitudinally adjusting mechanism by using extruded or extrusion profiles or shapes in an advantageous way. In particular, it is possible therewith to accommodate the adjusting mechanism inside the steering housing in such a way that thereby no injuries can be caused in an accident.

Based on FIGS. 3 to 5, it is clear that the guiding plate, the steering housing which can be shifted for a crash case, and the vertically and horizontally adjustable steering column are made of extruded or extrusion profile or shape, respectively, which results in the already mentioned cost effectiveness. The package-optimised interleave also evident by the invention in the form of using extruded or extrusion profiles or shapes, leads to additional advantages, for example, in the case of space requirements. Furthermore, it is of advantage that the guiding plate is designed in the direction in which the profile runs and can serve as support for the longitudinally and vertically adjustable steering column, the especially inter-left embodied load absorber, preferably used driving pistons and pyrotechnic driving cartridges for a steering column movement in the case of a crash, and a knee air bag. Especially the possible integration of the knee air bag including the, e.g., tissue covered by a plate, is a further advantage.

The views of FIGS. 6 and 7 illustrate the possibility of an integration of unlocking units at the end wall sides suitable to the profiles for the alternating unlocking of the load absorbers.

The connection of the glidingly mounted steering housing in the guiding housing in connection with a driver arm for the movement of the steering column against one or two load absorbers depending on the driver's seat belt fastened condition (wearing or not wearing a seat belt) or the “shooting” of the steering column to the front in the driving direction of the vehicle, i.e., away from the driver, by means of a pyrotechnic charge using a piston with reverse lock with small drivers and in the second crash phase, is demonstrated in the illustration in FIG. 8.

The view of FIG. 9 results in the integration of a knee air bag and the supporting plate required therefore as well as an alternative knee impact plate in the extruded or extrusion profile or shapes.

FIG. 11 illustrates the embodiment of the steering column with tolerance-compensating lock on both sides for a longitudinal adjustment integrated in an extruded or extrusion profile or shape housing. This housing is again integrated in a housing made of extruded or extrusion profile or shape for the vertical adjustment which at the same time is mounted in a guiding plate also made of extruded or extrusion profile or shape, shiftable against a load absorber in a crash.

All features described above correspondingly to the contents of FIGS. 3 to 10 are combined in the design according to the illustration of FIG. 12 additionally with a steering column with a “tab adjustment mechanism”. Thereto, FIG. 13 shows a sliding plate made of metal sheet with integrated bearing supports for the adjustment tabs for the vertical or height adjustment of the steering column. This sliding plate can have an integrated driver between the crash-relevant shifting part of the steering column and the pyrotechnic adjustment unit and the load absorbers.

The pyrotechnically driven switch units mounted on the power unit for locking and unlocking the load absorbers by means of swivel levers are visible in FIGS. 15 to 17.

The invention is illustrated based on the embodiment examples in the specification and in the drawings only by example and not restricted thereto but comprises all variations, modifications, substitutions and combinations which an ordinary person skilled in the art can derive from the present document, in particular in the scope of the claims and the general description in the introduction of this specification as well as the description of the embodiment examples and the illustration thereof in the drawing, and can combine with his expert knowledge as well as the prior art. In particular, all individual features and embodiment possibilities of the invention and the embodiment examples thereof can be combined.

Reference Symbols

1 guiding plate

2 outer housing

3 steering shaft

4 steering shaft housing

5 lock screw

6 positioning lever

7 adjustment slot

8 equalizing spring

9 swivel bearing

10 generator

11 load absorbency

12 load absorbency

13 unlocking

14 unlocking

15 piston

16 reverse lock

17 cartridge

18 unlocking of inner load absorbers

19 unlocking casing

20 cartridge

21 unlocking of outer load absorbers

22 piston rod

23 housing

24 connecting tab

25 knee air bag

26 support wall

27 bellville springs

28 load transmission casing

29 gliding stones

30 cylinder-shaped cavity

31 slip plate

32 driver

33 bearing supports

34 load absorber

35 load absorber

36 lever

37 lever

38 unlocking cartridge

39 unlocking cartridge

40 steering casing

41 casing

42 casing

43 cover

100 steering column

1. A steering column characterized in that an outer housing, a steering shaft housing and a guiding plate at least one of which is constructed in an extruded profile or in extruded profiles, said steering column having an knee airbag.

2. The steering column according to claim 1, characterized in that means for longitudinal and vertical adjustment of the steering column are accommodated in the extruded profile or in the extruded profiles.

3. The steering column according to claim 2, characterized in that the means for longitudinal and vertical adjustment of the steering column are accommodated in the extruded profiles of the guiding plate and the outer housing.

4. The steering column according to claim 1, characterized in that a means for an accident-caused movement of the steering column away from a driver are accommodated in the extruded profile or in the extruded profiles.

5. The steering column according to claim 4, characterized in that the means for the accident-caused movement of the steering column away from the driver include load absorbing means which are accommodated in the extruded profile or in the extruded profiles.

6. The steering column according to claim 5, characterized in that the load absorbing means include two load absorbencies which can be activated or deactivated in dependence on a seat belt fastened condition and/or the size of the driver.

7. The steering column according to claim 4, characterized in that the means for the accident-caused movement of the steering column away from the driver are accommodated in the extruded profiles of the guiding plate and the outer housing.

8. The steering column according to claim 4, characterized in that the means for the accident-caused movement of the steering column away from the driver include pyrotechnic or electronic driving means which are accommodated in the extruded profile or in the extruded profiles.

9. The steering column according to claim 4, characterized in that the means for the accident-caused movement of the steering column away from the driver include pyrotechnic or electronic unlocking means for the longitudinal adjustment of the steering column and unlocking or locking means for the load absorbing means.

10. The steering column according to claim 1, characterized in that a means for protection of a driver's knees or legs are integrated in the extruded profile or in the extruded profiles.

11. The steering column according to claim 10, characterized in that the means for the protection of the driver's knees or legs include a knee/leg air bag and a knee impact plate especially moveable towards the driver in an accident and preferably load-absorbingly mounted.

12. The manufacturing method for a steering column, characterized in that an outer housing, a steering shaft housing and a guiding plate are at least partly made of extruded profile.
